(19) United States
(12) Patent Application Publication
(10) Pub. No.: US 2025/0318686 A1
(43) Pub. Date: Oct. 16, 2025

(54) MILK FROTHER

(71) Applicant: Jiangmen BNG Industrial Co., LTD, Jiangmen City (CN)

(72) Inventor: Baoruan ZOU, Jiangmen City (CN)

(73) Assignee: Jiangmen BNG Industrial Co., LTD, Jiangmen City (CN)

(21) Appl. No.: 18/631,543

(22) Filed: Apr. 10, 2024

(51) Int. Cl. A47J 43/046

(52) U.S. Cl. CPC A47J 43/046

(57) ABSTRACT

A milk frother is disclosed, including: a cup body, including a fixed column positioned in the middle of the cup body, and a limiting groove arranged at an outer wall of the fixed column; a stirring head, including a base with a limiting fixture block, and a spring ring sleeved on the base. The fixed column penetrates through a middle of the base. The limiting fixture block extends into the limiting groove and presses against a groove wall of the limiting groove.

### FIELD OF THE INVENTION

The disclosure relates to the technical field of household appliances, in particular to a milk frother.

### BACKGROUND OF THE INVENTION

A milk frother is an appliance for producing milk foam, which is usually added to coffee. The milk foam can be mixed with coffee to make cappuccino, latte, etc. In related technology, a stirring head arranged in a cup body of a milk frother is configured to be driven by a motor to rotate, thereby driving liquid contained in the cup body to rotate. In this way, a stirring function of the milk frother is realized. However, the related milk frother generally has a problem that the stirring head falls off when the cup body is lifted for pouring milk foam, which easily causes a damage of the stirring head and influences use experiences of users.

### SUMMARY OF THE INVENTION

A milk frother is provided in the present disclosure. A limiting structure is formed between a stirring head and a cup body of the milk frother.

According to an embodiment of the present disclosure, a milk frother is provided, including: a cup body, including a fixed column positioned in the middle of the cup body, and a limiting groove arranged at an outer wall of the fixed column; a stirring head, t including a base with a limiting fixture block, and a spring ring sleeved on the base. The fixed column penetrates through a middle of the base. The limiting fixture block extends into the limiting groove, and presses against a groove wall of the limiting groove.

According to an embodiment of the present disclosure, the limiting groove extends along a circumferential direction of the fixed column. Two limiting fixture blocks are oppositely arranged to respectively presses against two sides of the limiting groove.

According to an embodiment of the present disclosure, an arc-shaped recess is arranged at an end of the limiting fixture block, and suitable for clamping the limiting groove.

According to an embodiment of the present disclosure, a top of the fixed column has a spherical groove. The base includes a semicircular supporting portion. The semicircular supporting portion includes a positioning column. The positioning column includes a spherical protuberance. The spherical protuberance is matched with the spherical groove.

According to an embodiment of the present disclosure, the positioning column is in threaded connection with a middle of the semicircular supporting portion. The positioning column includes a handle portion extending upwards.

According to an embodiment of the present disclosure, the base includes a support ring sleeved with the spring ring.

According to an embodiment of the present disclosure, a concave groove is formed in a bottom wall of the cup body, and a part of a lower portion of the fixed column extends into the concave groove.

According to an embodiment of the present disclosure, the milk frother further includes a pedestal with a stirring motor. The base includes a first magnet. An actuating shaft of the stirring motor is fixedly connected with a second magnet. The second magnet is in a magnetic connection with the first magnet, so as to drive the first magnet and the base to rotate together.

According to an embodiment of the present disclosure, the pedestal includes a support with a heat-generating plate. The heat-generating plate is positioned below the cup body and configured to heat the cup body.

According to an embodiment of the present disclosure, the pedestal includes a microswitch, a detection block and a compression spring. A lower end of the detection block is in a transmission connection with a trigger portion of the microswitch through the compression spring. An upper end of the detection block extends out of the pedestal for being pressed against by the cup body.

Additional aspects and advantages of the present disclosure will be set forth in part in the description below and, and the others will be obvious from the description, or may be learned by practice of the present disclosure.

### BRIEF DESCRIPTION OF THE DRAWINGS

The above and/or additional aspects and advantages of the present disclosure will become apparent and readily appreciated from the following description of the embodiments, taken in conjunction with accompanying drawings of which:

FIG. 1 is an exploded view of a part of a cup body of a milk frother according to embodiments of the present disclosure;

FIG. 2 is a cross-sectional view of a part of a cup body of a milk frother according to embodiments of the present disclosure;

FIG. 3 is a cross-sectional schematic view of a structure of a milk frother according to an embodiment of the present disclosure.

The reference numbers are as follow:
cup body: 100, concave groove: 101, fixed column: 110, limiting groove: 1101, spherical groove: 1102;
stirring head: 200, base: 210, semicircular supporting portion: 211, limiting fixture block: 2111, arc-shaped recess: 2112, positioning column: 212, spherical protuberance: 2121, handle portion: 213, spring ring: 220, support ring: 230, a first magnet: 240;
pedestal: 300, stirring motor: 310, second magnet: 311, support: 320, heat-generating plate: 330, microswitch: 340, compression spring: 350, detection block: 360.

### DETAILED DESCRIPTION OF THE EMBODIMENTS

Embodiments of the present disclosure are described in detail below. An example of the embodiments is illustrated in the accompanying drawings, in which like reference numerals refer to the same or similar elements or elements having the same or similar function throughout. The embodiments described below with reference to the accompanying drawings are illustrative only for the purpose of explaining the present disclosure and should not be construed as limiting the present disclosure.

In the description of the present disclosure, it should be understood that the positional descriptions referred to, for example, the directions or positional relationships indicated above, below, front, back, left, right, etc., are based on the directions or positional relationships shown in the drawings, and are only for convenience of describing the present disclosure and simplifying the description, but do not indicate or imply that the device or element referred to must have a particular direction, or be constructed and operated in a particular direction, and therefore should not be construed as limiting the present disclosure.

In the description of the present disclosure, “several” means are one or more, “a plurality” means two or more, “greater than”, “less than”, “more than”, etc. are understood as excluding the number, and “above”, “below”, etc. are understood as including the number. Any description of first or second is intended only to distinguish technical features, it should not be understood as indicating or implying relative importance, or implicitly indicating the number of technical features indicated, or implicitly indicating the precedence of technical features indicated.

In the description of the present disclosure, unless otherwise specifically limited, terms such as set, mounted, connected, and the like should be understood broadly, and those skilled in the art can reasonably determine the specific meanings of the above terms in the present disclosure in combination with the details of the technical schemes.

In the description of the present disclosure, reference to the description of the terms “an embodiment”, “some embodiments”, “an illustrative embodiment”, “an example”, “a specific example”, or “some examples” or the like means that a particular feature, structure, material, or characteristic described in connection with the embodiment or example is included in at least one embodiment or example of the present disclosure. In this specification, the schematic representations of the terms used above do not necessarily refer to the same embodiment or example. Furthermore, the particular feature, structure, material, or characteristic described may be combined in any suitable manner in any one or more embodiments or examples.

A milk frother is an appliance for producing milk foam, which is usually added to coffee. The milk foam can be mixed with coffee to make cappuccino, latte, etc. In related technology, a stirring head arranged in a cup body of a milk frother is configured to be driven by a motor to rotate, thereby driving liquid contained in the cup body to rotate. In this way, a stirring function of the milk frother is realized. However, the related milk frother generally has a problem that the stirring head falls off when the cup body is lifted for pouring milk foam, which easily causes a damage of the stirring head and influences use experiences of users.

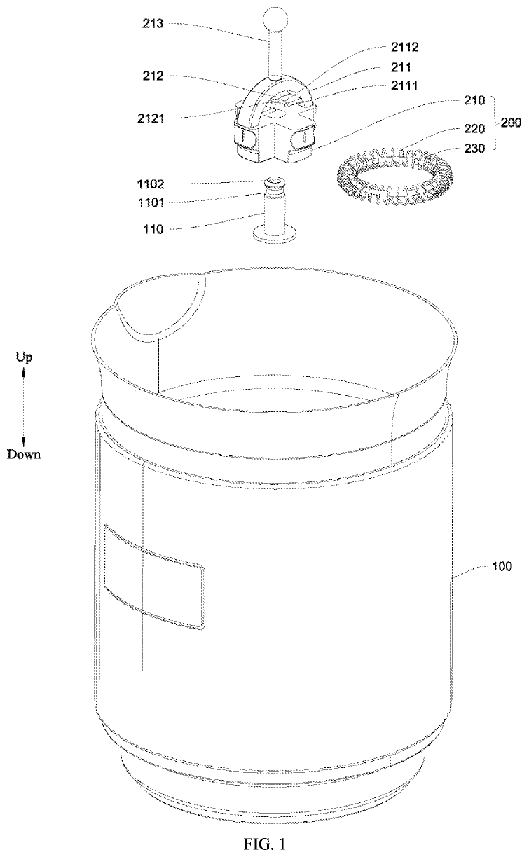

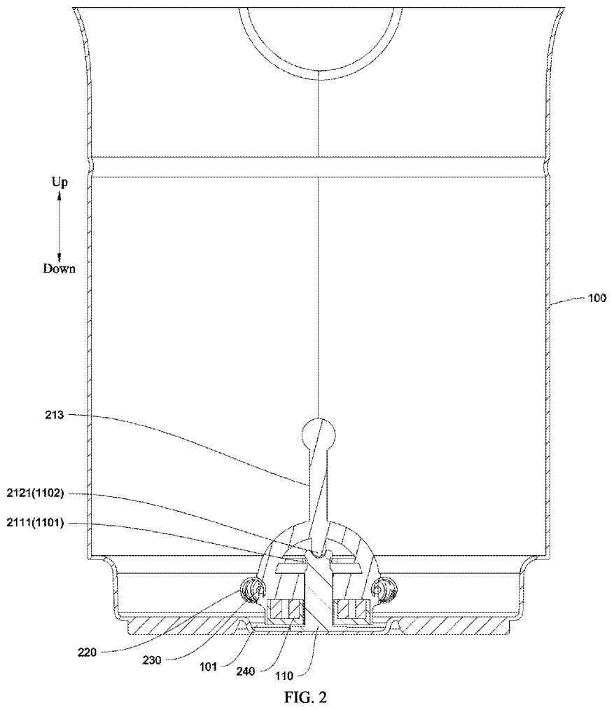

A milk frother is provided in the present disclosure, as shown in FIG. 1 and FIG. 2. The milk frother includes a pedestal 300, a cup body 100 mounted on the pedestal 300, and a stirring head 200 mounted in the cup body 100. A fixed column 110 is installed in the cup body 100. The fixed column 110 is located at a middle of the cup body 100. The stirring head 200 includes a base 210 and a spring ring 220 sleeved on the base 210. In an embodiment, an outer wall of the fixed column 110 has a limiting groove 1101. The base 210 has a limiting fixture block 2111. The fixed column 110 penetrates into a middle of the base 210. The limiting fixture block 2111 partially extends into the limiting groove 1101 and presses against a wall of the limiting groove 1101. It should be noted that, a limiting structure is formed between the stirring head 200 and the cup body 100, such that when the stirring head 200 is set on the fixed column 110, the limiting fixture block 2111 presses against the limiting groove 1101 of the fixed column 110 through a cooperation of the limiting fixture block 2111 and the limiting groove 1101. In such a way, the stirring head 200 does not fall off unexpectedly when the cup body 100 is lifted to pour out milk foam. The stirring head 200 will be removed from the fixed column 110 only when a user forcefully pulls the stirring head 200, thus, a risk of damaging the stirring head 200 is effectively reduced, and the user experience is improved. The limiting structure can prevent the stirring head from falling off when the cup body is lifted to pour out milk foam.

Referring again to FIG. 1 and FIG. 2, in some embodiments of the present disclosure, the limiting groove 1101 extends along a circumferential direction of the fixed column 110. Moreover, two limiting fixture blocks 2111 are oppositely arranged to respectively press against two sides of the limiting groove 1101, thereby improving the installation stability of the stirring head 200, and the stirring head 200 is less likely to falling off. In some embodiments, the base 210 has a semicircular supporting portion 211 protruding upward. The two limiting fixture blocks 2111 are symmetrically disposed at an inner side of the semicircular supporting portion 211. In some embodiments, an arc-shaped recess 2112 is disposed at an end portion of the limiting fixture block 2111, and adapted to engage the limiting groove 1101. The arc-shaped recess 2112 and the limiting groove 1101 are in a better fit, such that a possibility that the stirring head 200 falls off is further reduced.

In addition to a limiting structure on a peripheral wall of the fixed column 110, in some embodiments of the present disclosure, a positioning structure is also formed between a top of the fixed column 110 and the stirring head 200, to position the insertion depth of the stirring head 200. Referring again to FIG. 1 and FIG. 2, the top of the fixed column 110 is provided with a spherical groove 1102. The semicircular supporting portion 211 has a positioning column 212. The positioning column 212 has a spherical protuberance 2121 which matches with the spherical groove 1102. When the stirring head 200 is inserted into the fixed column 110 and reaches a predetermined depth, the spherical protuberance 2121 extends into the spherical groove 1102 and presses against a wall of the spherical groove 1102, so as to position a mounting height of the stirring head 200 and prevent the stirring head 200 from contacting a bottom of the cup body 100 to scratch the bottom wall of the cup body 100. In some embodiments, the base 210 is disposed with a support ring 230. The support ring 230 is sleeved with a spring ring 220. On one hand, a location of the spring ring 220 is determined by a mounting height of the support ring 230 to prevent the spring ring 220 from contacting the bottom wall of the cup 100 when sagging. On the other hand, the spring ring 220 is not easily detached from the base 210 during rotations of the stirring head 200, that is, a stability of the milk foamer is improved. In some embodiments, the positioning column 212 has a handle portion 213 extending upward, enabling a user to grasp the handle portion 213 and pull out the stirring head 200. The positioning column 212 is in a threaded connection with a middle of the semicircular supporting portion 211, such that an installation height of the positioning column 212 and the semicircular supporting portion 211 can be adjusted, and a user can take out the stirring head 200 in a more reliable way. It is easy to understand that, in addition to forcibly pulling the handle portion 213 upwards to remove the stirring head 200, the user can press the semicircular supporting portion 211 to limit a circumferential rotation of the semicircular supporting portion 211, then rotate the handle portion 213 to further screw the handle portion 213 into the semicircular supporting portion 211. The semicircular supporting portion 211 is pushed upwards in an opposite direction by a pressing of the spherical protuberance 2121 against the spherical groove 1102, thereby disengaging the limiting fixture block 2111 integrated with the semicircular supporting portion 211 from the limiting groove 1101, and separating the stirring head 200 from the fixed column 110. In some embodiments, the bottom wall of the cup body 100 has a concave groove 101. A part of a lower portion of the fixed column 110 extends into the concave groove 101, thus an installation position of the spring ring 220 can be properly shifted downward, and the stirring head 200 can efficiently mix the liquid at the bottom inside the cup body 100 when the milk frother is operated, thereby improving the stirring effect. It will be readily appreciated that, the stirring head 200 is able to stir milk more fully when the milk is used to produce milk foam, with a stirring position being on a lower side of an interior of the milk.

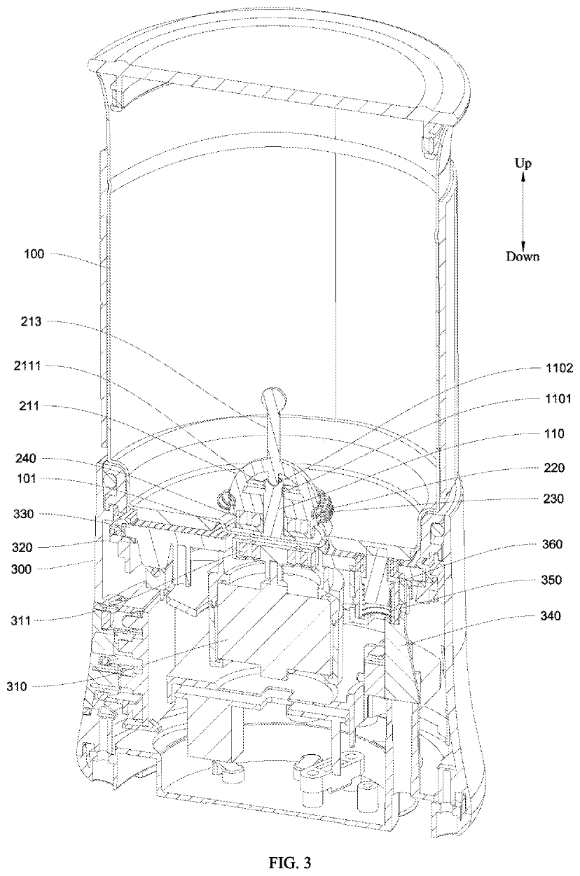

Referring again to FIG. 3, in some embodiments of the present disclosure, the pedestal 300 is mounted with a stirring motor 310. The base 210 is mounted with a first magnet 240. An actuating shaft of the stirring motor 310 is fixedly connected with a second magnet 311. The second magnet 311 is in a magnetic connection with the first magnet 240, so as to drive the first magnet 240 and the base 210 to rotate together. When the milk frother is working, the stirring motor 310 is configured to drive the second magnet 311 to rotate, and in turn drive the stirring head 200 to rotate together through a magnetic action of the second magnet 311 and the first magnet 240. The transmission is carried out under the action of a magnetic field without a direct physical contact, and the structure is simple. The assembly and disassembly of the stirring head 200 is more convenient. In some embodiments, the pedestal 300 has a support 320. The support 320 has a heat-generating plate 330 located below the cup body 100 and configured to heat the cup body 100. The efficiency of stirring and producing milk foam in the cup body 100 is further improved by heating the liquid in the cup body 100. For example, the support 320 is fixed to the pedestal 300 by a buckling method, which is more efficient in an installation process and improves the assembly efficiency compared to the conventional screw fastening method. In some embodiments, the cup body 100 is detachable from the pedestal 300. The pedestal 300 includes a microswitch 340, a detection block 360 and a compression spring 350. A lower end of the detection block 360 is in a transmission connection with a trigger portion of the microswitch 340 through the compression spring 350. An upper end of the detection block 360 extends out of the pedestal 300 for being pressed against by the cup body 100. It will be easily appreciated that, when the cup body 100 is placed on the pedestal 300, a bottom of the cup body 100 presses against the detection block 360, such that the detection block 360 in turn presses against the compression spring 350 and drives the compression spring 350 to compress, thereby trigging the microswitch 340. In such a way, it can be accurately detected whether the cup body 100 is placed on the base 300 or not.

The milk frother according to the embodiment of the present disclosure has at least the following beneficial effects. The limiting structure is formed between the stirring head and the cup body, such that when the stirring head is set on the fixed column, the limiting fixture block presses against the limiting groove of the fixed column through a cooperation of the limiting fixture block and the limiting groove. In such a way, the stirring head does not unexpectedly fall off when the cup body is lifted to pour out milk foam, and the stirring head will be removed from the fixed column only when a user forcefully pulls the stirring head. Thus, a risk of damaging the stirring head is effectively reduced, and the user experience is improved.

The embodiments of the present disclosure have been described in detail with reference to the accompanying drawings in above, but the present disclosure is not limited to the above embodiments, and various changes can be made within the knowledge of those having ordinary skill in the art without departing from the scope of the present disclosure.

1. A milk frother, comprising:
a cup body comprising a fixed column positioned in the middle of the cup body and a limiting groove arranged at an outer wall of the fixed column;
a stirring head comprising a base with a limiting fixture block and a spring ring sleeved on the base;
wherein, the fixed column penetrates through a middle of the base, and the limiting fixture block extends into the limiting groove and presses against a groove wall of the limiting groove.

2. The milk frother of claim 1, wherein, the limiting groove extends along a circumferential direction of the fixed column, and two limiting fixture blocks are oppositely arranged to respectively press against two sides of the limiting groove.

3. The milk frother of claim 2, wherein, an arc-shaped recess is arranged at an end of the limiting fixture block, and suitable for clamping the limiting groove.

4. The milk frother of claim 1, wherein, a top of the fixed column comprises a spherical groove, and the base comprises a semicircular supporting portion which comprises a positioning column with a spherical protuberance matched with the spherical groove.

5. The milk frother of claim 4, wherein, the positioning column is in threaded connection with a middle of the semicircular supporting portion, and the positioning column comprises a handle portion extending upwards.

6. The milk frother of claim 1, wherein, the base comprises a support ring sleeved with the spring ring.

7. The milk frother of claim 1, wherein, a concave groove is formed in a bottom wall of the cup body, and a part of a lower portion of the fixed column extends into the concave groove.

8. The milk frother of claim 1, further comprising a pedestal with a stirring motor, wherein the base comprises a first magnet, and an actuating shaft of the stirring motor is fixedly connected with a second magnet which is in a magnetic connection with the first magnet, so as to drive the first magnet and the base to rotate together.

9. The milk frother of claim 8, wherein, the pedestal comprises a support with a heat-generating plate positioned below the cup body and configured to heat the cup body.

10. The milk frother of claim 8, wherein, the pedestal comprises a microswitch, a detection block and a compression spring; and
wherein a lower end of the detection block is in a transmission connection with a trigger portion of the microswitch through the compression spring, and an upper end of the detection block extends out of the pedestal for being pressed against by the cup body.
